(19) United States
(12) Patent Application Publication
(10) Pub. No.: US 2016/0124765 A1
(43) Pub. Date: May 5, 2016

(54) RESOURCE ALLOCATION APPARATUS, METHOD, AND STORAGE MEDIUM

(71) Applicant: KABUSHIKI KAISHA TOSHIBA, Tokyo (JP)

(72) Inventors: Yu KANEKO, Kawasaki (JP); Toshio ITO, Kawasaki (JP); Tomonori MAEGAWA, Tokyo (JP)

(21) Appl. No.: 14/843,240

(22) Filed: Sep. 2, 2015

(30) Foreign Application Priority Data
Oct. 30, 2014 (JP) 2014-221595

(51) Int. Cl. G06F 9/455; G06F 9/50

(52) U.S. Cl. CPC G06F 9/45558; G06F 9/5077; G06F 2009/45591

(57) ABSTRACT

A dynamic resource allocation apparatus according to an embodiment includes a usage amount calculator, a spike detector, an allocation amount calculator, and an allocation amount setter. The usage amount calculator calculates a fixed usage amount which is a resource usage amount actually used for each time slot as a division of a resource fluctuation period of a virtual machine. The spike detector detects a spike of the fixed usage amount. The allocation amount calculator calculates a resource allocation amount to be allocated to the i-th time slot based on the past fixed usage amount in the i-th time slot and a detection result of a past spike in a time slot included in a predetermined range before and after the i-th time slot. The allocation amount setter sets an allocation amount to a virtual machine monitor which controls a virtual machine.

### CROSS REFERENCE TO RELATED APPLICATION(S)

This application is based upon and claims the benefit of priority from the prior Japanese Patent Application No. 2014-221595, filed on Oct. 30, 2014, the entire contents of which are incorporated herein by reference.

### FIELD

Embodiments described herein relate generally to a resource allocation apparatus, method, and storage medium.

### BACKGROUND

A software technique called a virtual machine monitor (hereinafter called a VMM) is conventionally used. Multiple virtual machines (hereinafter called a VM) can be operated on one computer by using the VMM.

The VMM has a function to allocate a resource to each VM, such as that 1 GB memory is allocated to a VM 1, and 2 GB memory is allocated to a VM 2. Further, the VMM can dynamically (i.e. without stopping the VM) change a resource to be allocated to each VM.

A resource needed by a VM can be allocated to the VM by using this function of VMM. The resource needed by a VM fluctuate depending on time. A computer's resource can be effectively used by allocating the resource in accordance with the fluctuation of the resource needed by a VM. A technique for implementing such a process is called a dynamic resource allocation technique.

In the dynamic resource allocation technique, it is important to assure a resource needed by a VM. Resource assurance means that more resources are allocated than resources needed by a VM. If the resources are not assured, an operation of a VM might be disturbed.

### BRIEF DESCRIPTION OF THE DRAWINGS

FIG. 1 is a block diagram illustrating a function configuration of a resource allocation apparatus according to an embodiment.

FIG. 2 is a graph illustrating an example of a resource usage amount used by a VM.

FIG. 3 is a graph describing a method for calculating a fixed usage amount.

FIG. 4 is graphs describing a method for calculating a fixed usage amount.

FIG. 5 is a graph describing a method for calculating a fixed usage amount.

FIG. 6 is tables indicating an example of a fixed usage amount stored in a usage amount storage.

FIG. 7 is a table indicating an example of a detection result of a spike stored in a spike storage.

FIG. 8 is a graph describing a method for calculating a fixed allocation amount.

FIG. 9 is a block diagram illustrating a hardware configuration of the resource allocation apparatus in FIG. 1.

FIG. 10 is a flowchart illustrating an operation of the resource allocation apparatus in FIG. 1.

FIG. 11 is a table indicating an example of a fixed usage amount stored in the usage amount storage.

FIG. 12 is a graph indicating a simulation result of a success rate of resource assurance.

### DETAILED DESCRIPTION

Embodiments will now be explained with reference to the accompanying drawings. The present invention is not limited to the embodiments.

A resource allocation apparatus according to the embodiment includes a usage amount calculator, a spike detector, an allocation amount calculator, and an allocation amount setter. The usage amount calculator calculates a fixed usage amount which is a resource usage amount actually used for each time slot as a division of a resource fluctuation period of a virtual machine. The spike detector detects a spike of the fixed usage amount. The allocation amount calculator calculates a resource allocation amount to be allocated to an i-th time slot based on the past fixed usage amount in the i-th time slot and a detection result of a past spike in a time slot included in a predetermined range before and after the i-th time slot. The allocation amount setter sets an allocation amount to a VMM which controls a VM.

A resource allocation apparatus 10 according to the embodiment (hereinafter called an apparatus 10) calculates a resource allocation amount based on a resource usage amount used by a VM and sets the calculated allocation amount to a VMM. Examples of the resource include a CPU, a memory, a storage, a hard disc, and a network. A VMM allocates the set allocation amount to a VM.

Hereinafter, a case where the apparatus 10 sets one allocation amount to one VMM will be described. However, the apparatus 10 may set allocation amounts to multiple VMMs, may set each of allocation amounts of multiple VMs controlled by one VMM, and may set each of allocation amounts of multiple type resources.

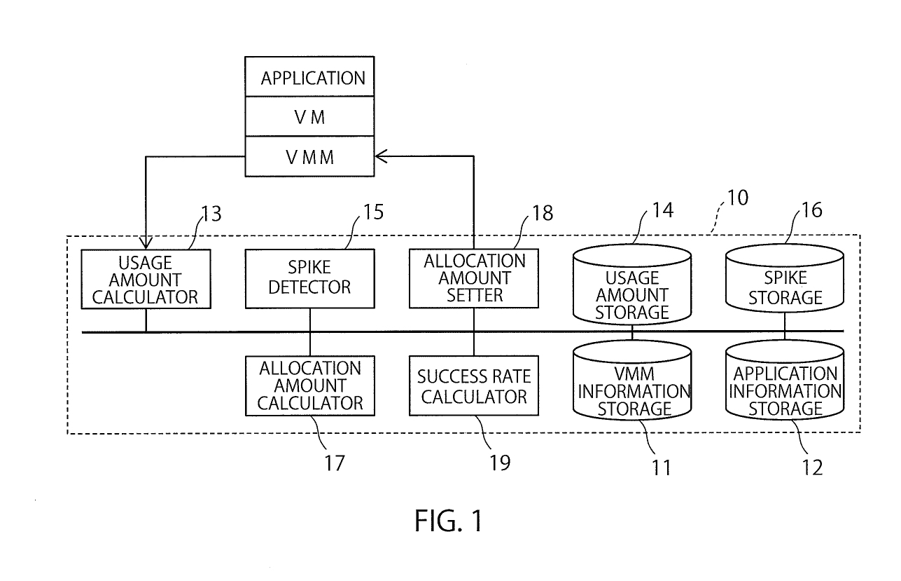

First, a function configuration of the apparatus 10 will be described with reference to FIGS. 1 to 8. FIG. 1 is a block diagram illustrating a function configuration of the apparatus 10. As illustrated in FIG. 1, the apparatus 10 includes a VMM information storage 11, an application information storage 12, a usage amount calculator 13, a usage amount storage 14, a spike detector 15, a spike storage 16, an allocation amount calculator 17, an allocation amount setter 18, and a success rate calculator 19.

The VMM information storage 11 stores VMM information. The VMM information is information on a VMM in which an allocation amount is to be set by the apparatus 10. The VMM information includes such as a VMM type, and an IP address and a port number for communication.

The application information storage 12 stores application information. The application information is information on an application operating on a VM. The application information include such as an identifier of the VM on which an application is operating, an operating period of the application, and operating accuracy to be required by the application. Operating accuracy herein means an allowable range of deviation in processing time.

The usage amount calculator 13 calculates a fixed usage amount fU. The fixed usage amount fU is a resource usage amount actually used by a VM in each time slot. A time slot will be described herein.

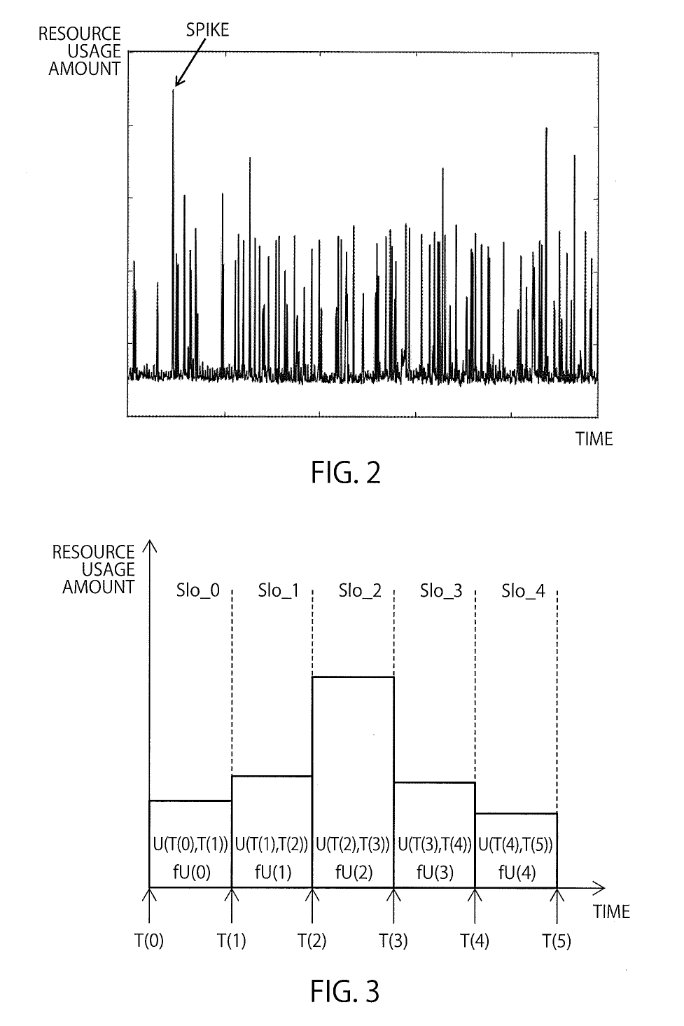

The apparatus 10 assumes, as an object in which an allocation amount is to be calculated, a VM which has a periodic resource usage pattern as illustrated in FIG. 2. In FIG. 2, a Y axis is a resource usage amount, and a X axis is a time. Such periodicity of a resource usage amount depends on an operating period of an application operating on a VM. While focusing on such periodicity, the apparatus 10 divides a period P, in which a resource usage amount changes, into multiple time slots having a predetermined time width d and calculates a resource allocation amount for each time slot.

The above-described period P may be previously set depending on an operating period of an application and may be derived by using a frequency analysis method using such as a fast Fourier transform (FFT). In addition, the time width d of each time slot included in the period P can be an arbitrary time which is shorter than operating accuracy required by an application.

For example, if the operating accuracy of an application is 10 milliseconds, the time width d of a time slot can be arbitrarily set to a time shorter than 10 milliseconds. If multiple applications are operating on a VM, the time width d of each time slot may be set to a time shorter than operating accuracy of an application having the highest operating accuracy. High operating accuracy means that short allowable range of deviation in processing time.

Hereinafter, the period P is assumed to be divided into N time slots (P=N×d). In addition, numbers i and j are allocated to each time slot.

The number i (0≦i≦N−1) specifies the time slot in each period P. Therefore, the same number i is allocated to a time slot and a time slot after an X period from the time slot. Hereinafter, a time slot in which the number i is allocated is called a time slot Slo_i.

On the other hand, the number j is a number to be uniquely allocated to each time slot and indicates which time slot is the allocated time slot in every time slots. Hereinafter, a time slot in which the number j is allocated is called a time slot slo_j. In addition, j=N×x+i (x is an arbitrary number more than 0).

The usage amount calculator 13 acquires an resource usage amount used by a VM at a predetermined timing to calculate the fixed usage amount fU. The usage amount can be acquired from a VMM and a VM. An acquisition interval of the usage amount by the usage amount calculator 13 is preferably shorter than operating accuracy of an application and, for example, is the time width d of a time slot.

The usage amount calculator 13 calculates the fixed usage amount fU based on a usage amount acquisition time T(i) and an acquired usage amount U(T(i)). The acquisition time T(i) is an acquisition time of the i-th time slot in each period. The usage amount U(T(i)) is a usage amount acquired at the time T(i).

Herein, FIGS. 3 to 5 are graphs describing a method for calculating the fixed usage amount fU. In FIGS. 3 to 5, a Y axis is a resource usage amount, and a X axis is a time.

When the usage amount calculator 13 acquires a usage amount U(T(i+1)) at a time T(i+1), the usage amount calculator 13 calculates U(T(i), T(i+1)). U(T(i), T(i+1)) is a usage amount from the time T(i) until T(i+1).

In the case where the usage amount U(T(i+1)) is an integrated value of usage amounts, the following formula is established: U(T(i), T(i+1))=U(T(i+1))−U(T(i)). In addition, in the case where the usage amount U(T(i+1)) is a usage amount from the time T(i) until the time T(i+1), the following formula is established: U(T(i), T(i+1))=U(T(i+1)). Whether the usage amount U(T(i)) is an integrated value is determined depending on a resource type. For example, in the case where a resource is a CPU, a CPU time which indicates a usage amount of the CPU is acquired as an integrated value.

When the usage amount calculator 13 acquires a usage amount U(T(0)) at a time T(0), the usage amount calculator 13 calculates a usage amount U(T(N−1), T(0)). U(T(N−1), T(0)) indicates a resource usage amount from a previous period time T(N−1) until a present period time T(0).

As illustrated in FIG. 3, in the case where the time T(i) is same as the starting time of the time slot Slo_i (the time T (i) is same as a finish time of a time slot Slo_i−1), a fixed usage amount fU(i) of the time slot Slo_i becomes fU(i)=U(T(i), T(i+1)).

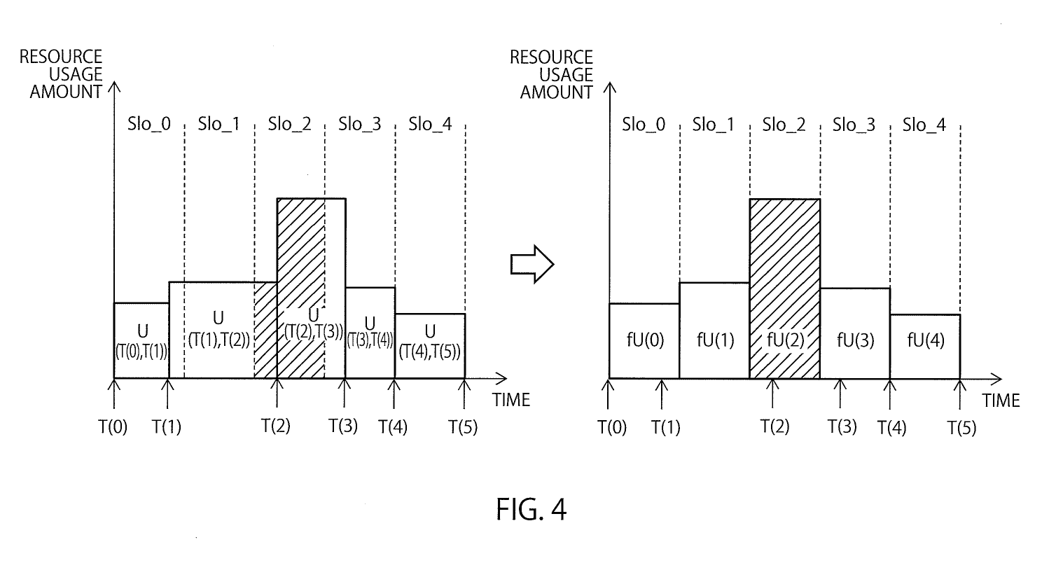

On the other hand, as illustrated in FIG. 4, the time T(i) and a starting time of the time slot Slo_i are shifted (the time T(i) and the finish time of the time slot Slo_i−1 are shifted), deviation is caused between U(T(i), T(i+1)) and the fixed usage amount fU(i). Specifically, the following formula is not established: fU(i)=U(T(i), T(i+1)). In the case where the apparatus 10 and a VMM are configured by a general computer and a general-purpose OS, a processing timing may be shifted for several tens microseconds to several milliseconds. In this case, the usage amount calculator 13 calculates, for example, the fixed usage amount fU(i) by the following method.

First, the usage amount calculator 13 calculates U(T(i), T(i+1)). A method for calculating U(T(i), T(i+1)) is as described above. Next, the usage amount calculator 13 divides U(T(i), T(i+1)) for each time slot and calculates a partial usage amount fu(i) of each time slot Slo_i. The partial usage amount fu(i) is a usage amount actually used for the time slot Slo_i in U(T(i), T(i+1)). The usage amount calculator 13 calculates the fixed usage amount fU(i) by adding up the partial usage amount fu(i) of the time slot Slo_i.

For example, after acquiring the usage amount U(T(2)) at the time T(2) indicated in FIG. 4, the usage amount calculator 13 calculates U(T(1), T(2)), divides U(T(1), T(2)) into time slots Slo_0, 1, and 2, and calculates partial usage amounts fu(0), fu(1), and fu(2). The partial usage amount fu(2) is an area of U(T(1), T(2)) indicated by hatched lines.

Next, after acquiring a usage amount U(T(3)) at a time T(3), the usage amount calculator 13 calculates U(T(2), T(3)), divides U(T(2), T(3)) into the time slots Slo_2 and 3, and calculates partial usage amounts fu(2) and (3). The partial usage amount fu(2) is an area of U(T(2), T(3)) indicated by hatched lines.

The usage amount calculator 13 calculates the fixed usage amount fU(2) of the time slot Slo_2 by adding up calculated two partial usage amounts fu(2).

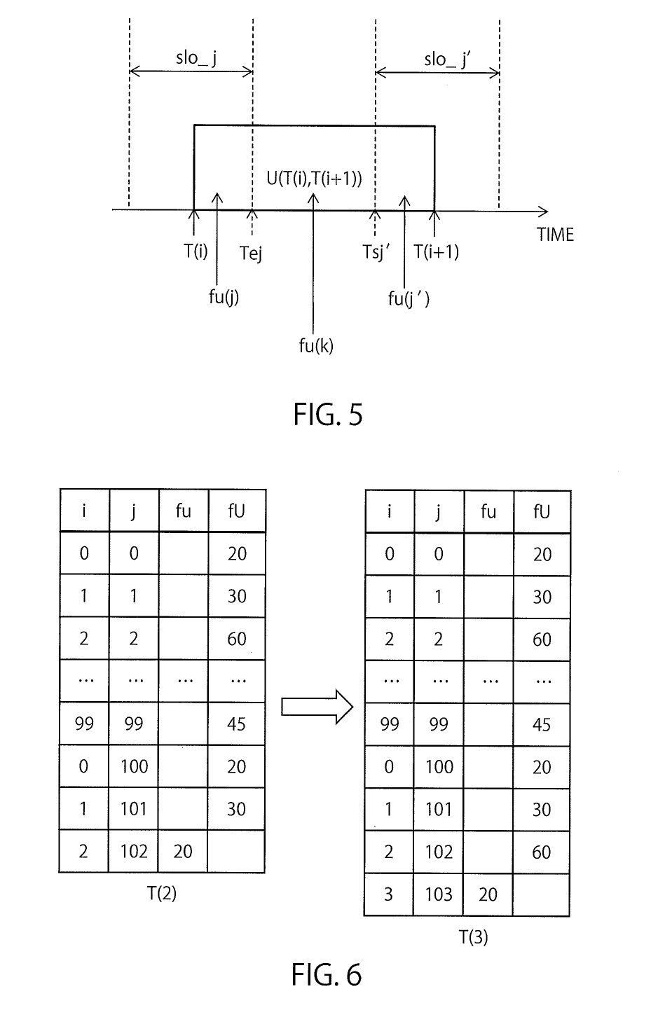

FIG. 5 is a graph describing a method for calculating the partial usage amount fu in detail. With reference to FIG. 5, a method for calculating the partial usage amount fu from U(T(i), T(i+1)) will be described. First, the usage amount calculator 13 acquires a serial number j of a time slot included in the time T(i) and a serial number j′ of a time slot included in the time T(i+1) to divide U(T(i), T(i+1)) for each time slot.

As described above, in the case where a serial number is allocated to each time slot in advance, the serial numbers j and j′ can be obtained by referring to a starting time and a finish time of each time slot.

In the case where a serial number is not allocated to each time slot in advance, the serial numbers j and j′ may be calculated by the following method.

j=T(i)÷d

j′=T(i+1)÷d

where a time is Epoch seconds (seconds elapsed since 00:00:00 on Jan. 1, 1970, Coordinated Universal Time (UTC)). A remainder is cut off.

In the case of j=j′, U(T(i), T(i+1)) is entirely included in the time slot slo_j. In this case, the usage amount calculator 13 causes the usage amount storage 14 to temporarily store U(T(i), T(i+1)) as the partial usage amount fu(j) of the time slot slo_j.

On the other hand, in the case of j<j′, U(T(i), T(i+1)) is divided to multiple time slots as illustrated in FIG. 5. Specifically, U(T(i), T(i+1)) includes a partial usage amount of multiple time slots.

In this case, the usage amount calculator 13 divides U(T(i), T(i+1)) into each time slot, calculates the partial usage amount fu of each time slot as described below, and causes the usage amount storage 14 to temporarily store the partial usage amount.

fu(j)=U(T(i),T(i+1))×(Tej−T(i))÷(T(i+1)−T(i))

fu(j)′=U(T(i),T(i+1))×(T(i+1)−Tsj′)÷(T(i+1)−T(i))

fu(k)(j<k<j′)=U(T(i),T(i+1))×d÷(T(i+1)−T(i))

In the above formula, Tej is a finish time of the time slot slo_j, and Tsj′ is a starting time of the time slot slo_j′. In addition, k is an arbitrary serial number which is larger than j and smaller than j′, and fu(k) is a partial usage amount of an arbitrary time slot slo_k between the time slot slo_j and the time slot slo_j′. For example, k=j+1=j′−1 in the case of FIG. 5.

In the case of j<j′, the usage amount calculator 13 calculates the fixed usage amount fU of a time slot, in which a fixed usage amount has not been calculated, in each time slot until the time slot slo_j′−1 by adding up partial usage amounts stored in the usage amount storage 14.

Herein, FIG. 6 is tables illustrating an example of the fixed usage amount fU stored in the usage amount storage 14. The left side of FIG. 6 indicates the fixed usage amount fU calculated at the time T(2) illustrated in FIG. 4. The right side of FIG. 6 indicates the fixed usage amount fU calculated at the time T(3) illustrated in FIG. 4. In FIG. 6, N=100 (i=0 to 99).

As indicated in FIG. 6, the usage amount storage 14 stores a fixed usage amount of time slots until a time slot Slo_1 (slo_101) at the time T(2) and temporarily stores a partial usage amount (fu(102)=20) of a time slot Slo_2 (slo_102).

According to FIG. 4, the time T(2) is included in the time slot Slo_2 (slo_102), and the time T(3) is included in a time slot Slo_3 (slo_103). Therefore, j=102 and j′=103 (j<j′) at the time T(3), and the usage amount calculator 13 calculates a partial usage amount (=40) of the time slot slo_102 and causes the usage amount storage 14 to temporarily store the partial usage amount (not illustrated). The usage amount calculator 13 calculates a fixed usage amount (=60) by adding up a partial usage amount (20+40) of the time slot slo_102 stored in the usage amount storage 14. In addition, the usage amount calculator 13 calculates a partial usage amount (=20) of the time slot slo_103 and cause the usage amount storage 14 to temporarily store the partial usage amount.

In FIG. 6, although a usage amount is a scalar value, the usage amount may be put a unit depending on a resource type. For example, if a resource is a CPU, a unit is a time or an number of instructions. If a resource is memory, a unit is kilobyte (KB) or megabyte (MB). If a resource is a network, a unit is KB/second or MB/second. If a resource is a disk, a unit is KB, MB, KB/second, and MB/second. In the embodiment, a unit of a resource usage amount can be arbitrarily selected depending on a resource type.

By the above-described method for calculating a fixed usage amount, even in the case where an acquisition timing of a usage amount by the usage amount calculator 13 and a starting time of each time slot are shifted, a fixed usage amount of each time slot can be calculated.

The spike detector 15 detects a spike with reference to a fixed usage amount of each time slot stored in the usage amount storage 14. The spike means a sudden increase in a resource usage amount as illustrated in FIG. 2.

The spike detector 15, for example, determines that a spike has occurred in the time slot Slo_(i+1) in the case where an increase amount of a fixed usage amount from the time slot Slo_i until the time slot Slo_i+1 is larger than a threshold s₁: (fU(i+1)−fU(i)>s₁).

In addition, the spike detector 15 may determine that a spike has occurred in the time slot Slo_(i+1) in the case where an increase ratio of the fixed usage amount from the time slot Slo_i until the time slot Slo_i+1 is larger than a predetermined threshold s₂: (fU(i+1)−fU(i)≧s₂).

Further, the spike detector 15 may determine that a spike has occurred in the time slot Slo_i+1 in the case where fU(i+1)−fU(i)>s₁, fU(i+1)÷fU(i)>s₂, and a fixed usage amount of the time slot Slo_i+1 are larger than an average value E(fU) of the past fixed usage amount: (fU(i+1)>E(fU)). The average value E(fU) may be an average value of a fixed usage amount of past all time slots and may be an average value of a fixed usage amount of the nearest arbitrary number of time slots.

A detection interval of a spike by the spike detector 15 is preferably shorter than operating accuracy of an application and, for example, is the time width d of a time slot. The spike detector 15 detects, for example, a spike with respect to a time slot, in which a fixed usage amount has been calculated, after a fixed usage amount and a partial usage amount at the time T(i) have been calculated.

A detection result of a spike by the spike detector 15 is stored in the spike storage 16. The spike storage 16 stores a serial number j and a fixed usage amount fU of a time slot in which a slot has been detected, as a detection result of the spike.

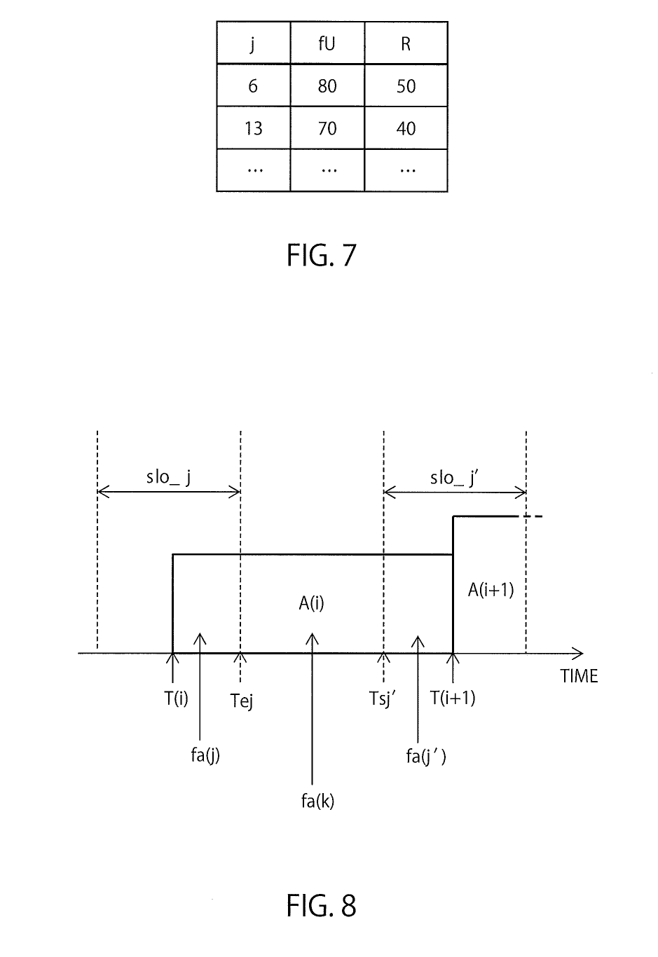

FIG. 7 is a table illustrating an example of a detection result of a spike stored in the spike storage 16. In FIG. 7, the spike storage 16 stores the serial number j of a time slot in which a spike has been detected, the fixed usage amount fU of the time slot in which the spike has been detected, and an increase rate R((fU(i+1)÷fU(i−1))×100) of the fixed usage amount fU. The increase rate R (%) can be used for calculation of a resource allocation amount to be described later.

The allocation amount calculator 17 calculates a resource allocation amount of a resource to be allocated to each time slot. A calculation interval of an allocation amount by the allocation amount calculator 17 is preferably shorter than operating accuracy of an application and, for example, is the time width d of a time slot. The allocation amount calculator 17 calculates, for example, an allocation amount A(i+1) to be allocated to the time slot Slo_i+1 at the time T(i). Hereinafter, a method for calculating an allocation amount will be described.

The allocation amount calculator 17 acquires the serial number j of a time slot including the time T(i) at the time T(i). A method for acquiring the serial number j will be as described below.

Next, the allocation amount calculator 17 acquires a fixed usage amount fU(i+1) of a time slot group i+1 from the usage amount storage 14. The time slot group i+1 is a group of past multiple time slots Slo_i+1. The time slot group i+1 includes m time lots in which serial numbers i+1−N, i+1−2N, i+1−3N, . . . , i+1−mN (m is an arbitrary integer) are allocated. Therefore, the allocation amount calculator 17 acquires the fixed usage amount fU(i+1) of the m time lots.

As described above, a number of time slots N included in the period P may be set in advance and may be calculated by P+d (a remainder is cut off). Also, a serial number group of time slots included in the time slot group i+1 is called a serial number i+1.

In the embodiment, a VM in which a resource usage amount is periodically changed is assumed as an object in which an allocation amount is to be set. In the case where a resource usage amount is periodically changed, the resource usage amount of the time slot Slo_i+1 in which an allocation amount A(i+1) is calculated by the allocation amount calculator 17 and the resource usage amount of the past time slots Slo_i+1 are assumed to be comparable.

Therefore, first the allocation amount calculator 17 calculates a temporary allocation amount A(i+1)′ based on the fixed usage amount fU(i+1) of m time slots in the time slot group i+1. The temporary allocation A(i+1)′ is a temporary allocation amount to be calculated based on the past fixed usage amount fU(i+1).

The allocation amount calculator 17, for example, sets the maximum value of the fixed usage amount fU(i+1) of m time slots to the temporary allocation amount A(i+1)′.

A(i+1)′=max(fU(i+1) of m time slots)

In addition, the allocation amount calculator 17 may calculate a value larger than an average value of the fixed usage amount fU(i+1) of m time slots by a predetermined threshold s₃ as the temporary allocation amount A(i+1)′.

A(i+1)′=average (fU(i+1) of m time slots)+s₃

In addition, the allocation amount calculator 17 may calculate the temporary allocation amount A(i+1)′ so that an allowance with respect to the maximum value of the fixed usage amount fU(i+1) of m time slots becomes a threshold value s₄%.

A(i+1)′=max(fU(i+1) of m time slots)÷(1−(s₄÷100))

where 0<s₄<100.

Further, the allocation amount calculator 17 may calculate the temporary allocation amount A(i+1)′ considering a success rate of resource assurance p %.

A(i+1)′=max(fU(i+1) of m time slots)÷p

where 0<p<100.

A method for calculating a success rate p will be described later.

Further, the allocation amount calculator 17 may calculate the temporary allocation amount A(i+1)′ considering a success rate of resource assurance p % in the time slot group i+1.

A(i+1)′=max(fU(i+1) of m time slots)÷p′

where 0<p′<100.

A method for calculating a success rate p′ will be described later.

The allocation amount calculator 17 corrects the temporary allocation amount A(i+1)′ and calculates the allocation amount A(i+1) based on a detection result of past spikes in time slots included in a predetermined range before and after the time slot Slo_i+1 after calculating the temporary allocation amount A(i+1)′.

One or multiple time slots, in which a spike detection result is used to calculate the allocation amount A(i), can be arbitrarily selected among time slots Slo_i±w (w is a natural number more than 0). For example, the allocation amount calculator 17 may use a detection result of past spikes in the time slots Slo_i−1, i+1 and may use the detection result of past spikes in the time slots Slo_i−2, i+2. Hereinafter, the allocation amount calculator 17 uses a detection result of past spikes in the time slots Slo_i−1, i+1, specifically time slots before and after the time slot Slo_i, to calculate the allocation amount A(i).

First, the allocation amount calculator 17 confirms whether a spike is detected in the time slot group i and a time slot group i+2 with reference to the spike storage 16. For example, in the case where serial numbers included in the serial number group i+1 are 5, 10, and 15, the allocation amount calculator 17 confirms a spike detection result in time slots in which serial numbers 4, 6, 9, 11, 14, and 16 are allocated.

In the case where a spike is not detected in at least either of the time slot group i and the time slot group i+2, a temporary allocation amount A(i+1)′ becomes an allocation amount A(i+1): (A(i+1)′=A(i+1)).

On the other hand, in the case where a spike is detected in at least either of the time slot group i and the time slot group i+2, the allocation amount calculator 17 calculates the allocation amount A(i+1) so as to be larger than the temporary allocation amount A(i+1)′.

The allocation amount calculator 17, for example, corrects the temporary allocation amount A(i+1)′ by a correction amount α (>0) and calculates the allocation amount A(i+1): (A(i+1)=A(i+1)′+α). The correction amount α may be set in advance and may be calculated by the allocation amount calculator 17.

The allocation amount calculator 17, for example, calculates the correction amount α so that the allocation amount A(i+1) becomes equal to a fixed usage amount in a time slot in which a spike has been detected (hereinafter called a spike usage amount).

α=spike usage amount−A(i+1)′

Further, the allocation amount calculator 17 may calculate e % of the spike usage amount as the correction amount α.

α=spike usage amount×e÷100

where 0<e<100.

In addition, the allocation amount calculator 17 may calculate the correction amount α considering a success rate of resource assurance p %.

α=(spike usage amount−A(i+1)′)×(1−p)

where 0<p<100.

A method for calculating a success rate p will be described later.

Further, the allocation amount calculator 17 may calculate the correction amount α considering an increase rate R % of a fixed usage amount in a time slot in which a spike has been detected.

α=spike usage amount×R÷100

where 0<R<100.

The allocation amount calculator 17 may correct the temporary allocation amount A(i+1)′ by a correction factor β(>1) and may calculate the allocation amount A(i+1): (A(i+1)=A(i+1)′×β). The correction factor β may be set in advance and may be calculated by the allocation amount calculator 17.

In addition, the allocation amount calculator 17 may correct the temporary allocation amount A(i+1)′ with reference to a spike detection result either in the time slot group i or the time slot group i+2.

By calculating the allocation amount A(i+1) in this manner, a resource allocation amount to be allocated to time slots before and after the time slot, in which a spike has occurred in the past, can be increased.

The allocation amount setter 18 sets the allocation amount A(i+1) calculated by the allocation amount calculator 17 to a VMM. A setting interval of the allocation amount A(i+1) by the allocation amount setter 18 is preferably shorter than operating accuracy of an application and, for example, is the time width d of a time slot. The allocation amount setter 18, for example, sets the allocation amount A(i+1) to the time T(i+1).

In addition, the allocation amount setter 18 converts a unit as necessary when the allocation amount A(i+1) is set. For example, in the case where the allocation amount A(i+1) calculated by the allocation amount calculator 17 is a CPU time, and an allocation amount required by a VMM is a CPU operating rate, the allocation amount A(i+1) cannot be set to the VMM as it is. In this case, the allocation amount setter 18 converts a CPU time to a CPU operating rate.

Further, the allocation amount setter 18 calculates a fixed allocation amount fA after the allocation amount A(i+1) is set to the time T(i+1). The fixed allocation amount fA is an actual resource allocation amount for each time slot allocated to a VM. The fixed allocation amount fA is used to calculate a success rate of resource assurance to be described later. A method for calculating the fixed allocation amount fA is same as the method for calculating a fixed usage amount.

Specifically, if the time T(i) and a starting time of the time slot Slo_i are consistent, the fixed allocation amount fA(i) becomes the allocation amount A(i).

On the other hand, if the time T(i) and the starting time of the time slot Slo_i are shifted, the allocation amount setter 18 divides the allocation amount A(i) to each time slot and calculates a partial allocation amount fa of each time slot. Then, a partial allocation amount fa for each time slot are added up, and a fixed allocation amount fA of each time slot is calculated.

FIG. 8 is a graph describing a method for calculating the partial allocation amount fa in detail. The allocation amount setter 18 acquires the serial number j of a time slot included in the time T(i) and the serial number j′ of a time slot included in the time T(i+1) to divide the allocation amount A(i), which has been set last time, to each time slot after the allocation amount A(i+1) has been set in the time T(i+1). A method for acquiring the serial numbers j and j′ is as described above.

In the case of j=j′, the allocation amount A(i) is entirely included in the time slot slo_j. In this case, the allocation amount setter 18 temporarily causes the usage amount storage 14 to store the allocation amount A(i) as the partial usage amount fa(j) of the time slot slo_j.

On the other hand, in the case of j<j′, the allocation amount A(i) is divided to multiple time slots as illustrated in FIG. 8. Specifically, the allocation amount A(i) includes the partial allocation amount fa of the multiple time slots.

In this case, the allocation amount setter 18 divides the allocation amount A(i) to each time slot, calculates the partial usage amount fa of each time slot as follows, and causes the usage amount storage 14 to temporarily store the partial usage.

fa(j)=A(i)×(Tej−T(i))÷(T(i+1)−T(i))

fa(j′)=A(i)×(T(i+1)−Tsj′)÷(T(i+1)−T(i))

fa(k)(j<k<j′)=A(i)×d÷(T(i+1)−T(i))

In the case of j<j′, the allocation amount setter 18 calculates the fixed allocation amount fA of a time slot, in which a fixed usage amount is not calculated, in each time slot until the time slot slo_j′−1 by adding up partial usage amounts stored in the usage amount storage 14. The fixed allocation amount fA calculated by the allocation amount setter 18 is stored in the usage amount storage 14.

The success rate calculator 19 calculates a success rate of resource assurance. The success rate calculator 19, for example, may calculate a success rate every time a new fixed usage amount fU and a new fixed allocation amount fA are stored in the usage amount storage 14 and may calculate a success rate upon request from the allocation amount calculator 17.

First, the success rate calculator 19 acquires the fixed usage amount fU and the fixed allocation amount fA of multiple time slots with reference to the usage amount storage 14. In this case, the success rate calculator 19 may acquire all of the past fixed usage amount fU and the past fixed allocation amount fA stored in the usage amount storage 14 and may acquire the fixed usage amount fU and the fixed allocation amount fA of an arbitrary number of recent time slots.

Next, the success rate calculator 19 determines whether resource assurance has succeeded in each time slot. The success rate calculator 19 determines that the resource assurance of the time slot Slo_i has succeeded, for example, in the case where the fixed allocation amount fA(i) is equal to or greater than the fixed usage amount fU(i): (fA(i)≧fU(i)).

In addition, the success rate calculator 19 may determine that the resource assurance of the time slot Slo_i has succeeded, in the case where the fixed allocation amount fA(i) is equal to or greater than the fixed usage amount fU(i) by a predetermined threshold s₅: (fA(i)≧fU(i)+s₅).

Further, the success rate calculator 19 may determine that the resource assurance of the time slot Slo_i has succeeded in the case where an allowance with respect to the fixed usage amount fU(i) of the fixed allocation amount fA(i) is equal to or greater than a predetermine threshold s₆%: (fA(i)×(100−s₆)÷100≧fU(i)).

A success or failure of resource assurance in each time slot determined by the success rate calculator 19 is stored in the usage amount storage 14.

The success rate calculator 19 determines whether assurance has succeeded in each time slot and then calculates the assurance success rate p by the following formula.

p=a number of time slots which have been determined that assurance has succeeded÷a number of all time slots which have been determined.

In addition, the success rate calculator 19 may calculate the resource assurance success rate p′ in a specific time slot group. The success rate calculator 19, for example, can calculate the success rate p′ of the time slot group i+1 by acquiring the fixed usage amount fU(i+1) and the fixed allocation amount fA(i+1) of the time slot group i+1 from the usage amount storage 14 and calculating the success rate p′ by the above-described method.

The success rates p and p′ calculated by the success rate calculator 19 can be used to calculate an allocation amount as described above.

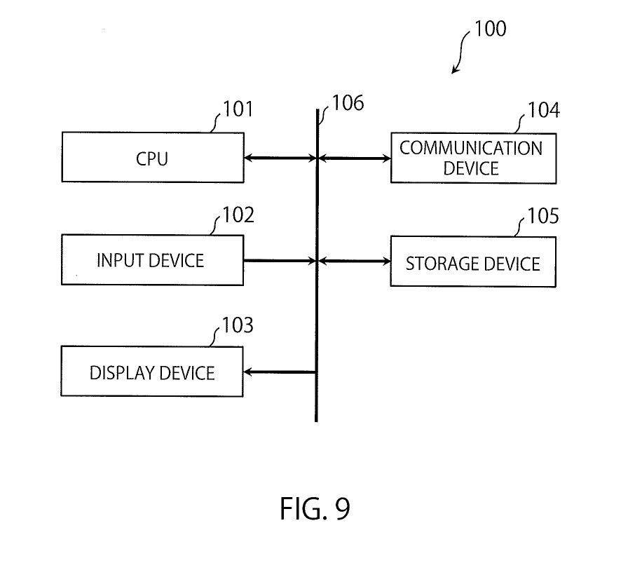

Next, a hardware configuration of the apparatus 10 according to the embodiment will be described with reference to FIG. 9. The apparatus 10 according to the embodiment is configured by a computer 100 as illustrated in FIG. 9. The computer 100 includes a central processing unit (CPU) 101, an input device 102, a display device 103, a communication device 104, and a storage device 105, and these devices are connected each other by a bus 106.

The CPU 101 is a control device and an arithmetic device of the computer 100. The CPU 101 executes an operating system (OS) of the computer 100 and a resource allocation program and controls each device included in the computer 100. The resource allocation program is a program to cause the computer 100 to realize above-described each function configuration of the apparatus 10. The computer 100 functions as the apparatus 10 when the CPU 101 executes the resource allocation program.

The input device 102 is a device configured to input information to the computer 100. Examples of the input device 102 include, but are not limited to, a keyboard, a mouse, and a touch panel. A user can input information such as VMM information and application information by using the input device 102.

The display device 103 is a device configured to display a picture and an image. Examples of the display device 103 include, but are not limited to, a liquid crystal display (LCD), a cathode-ray tube (CRT), and a plasma display panel (PDP). The display device 103 can display VMM information, application information, and information on a fixed usage amount, a fixed allocation amount, a spike detection result, and a success or failure of resource assurance.

The communication device 104 is a device by which the computer 100 communicates with an external device by a wireless or wired channel. Examples of the communication device 104 include, but are not limited to, a modem, a hub, and a router. Information on such as a VMM and an application may be input from an external device via the communication device 104.

The storage device 105 is a storage medium for storing an OS of the computer 100, a resource allocation program, data necessary for executing the resource allocation program, and data generated by executing the resource allocation program. The storage device 105 includes a main storage and an external storage.

Examples of the main storage include, but are not limited to, RAM, DRAM, and SRAM. Examples of the external storage include, but are not limited to, a hard disk, an optical disk, flash memory, and a magnetic tape. The VMM information storage 11, the application information storage 12, the usage amount storage 14, and the spike storage 16 are included in the storage device 105.

The computer 100 may include one or a plurality of the CPU 101, the input device 102, the display device 103, the communication device 104, and the storage device 105, and may be connected to peripherals such as a printer and a scanner.

In addition, the apparatus 10 may be configured by a single computer 100 and may be configured as a system including multiple computers 100 connected each other.

Further, a resource allocation program may be stored in the storage device 105 of the computer 100 in advance, may be stored in a storage medium such as a CD-ROM, and may be uploaded on the Internet. In any case, the apparatus 10 can be configured by installing a resource allocation program in the computer 100 and executing the program.

In addition, the resource allocation program and a VMM may be executed by the same computer 100 and may be executed by separate computers 100 connected each other.

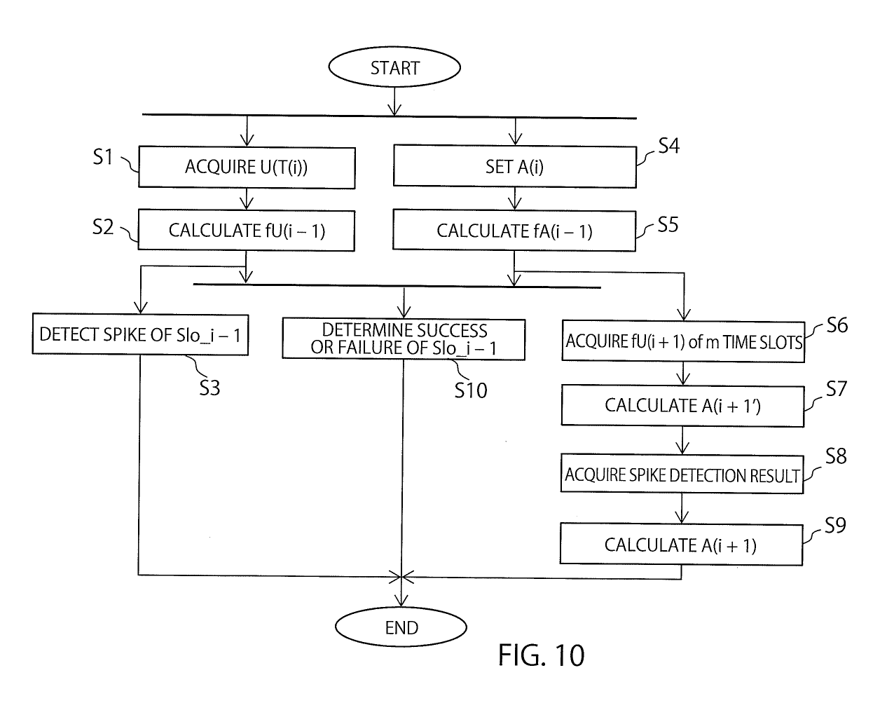

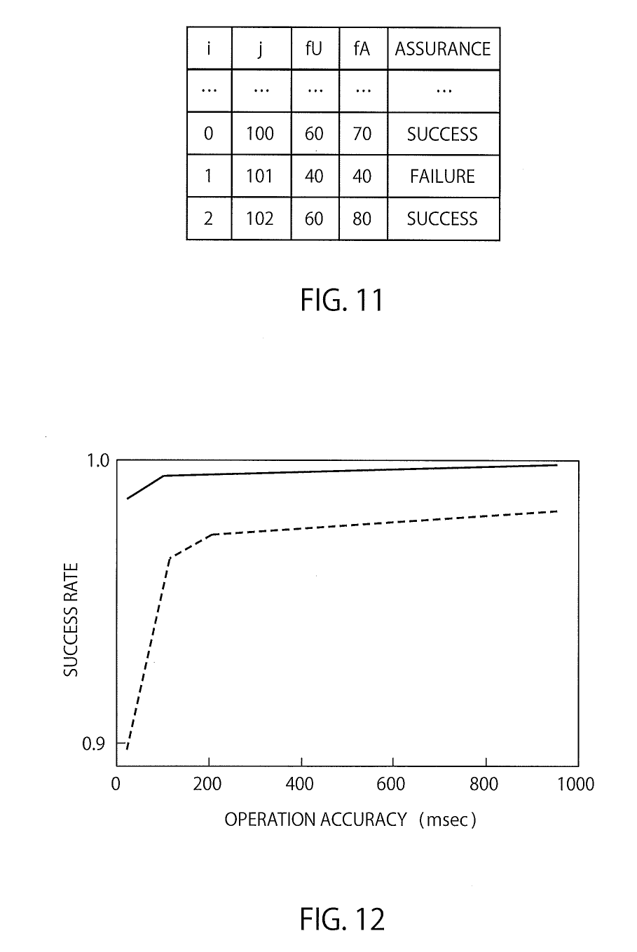

Next, an operation of the apparatus 10 will be described with reference to FIGS. 10 and 11. FIG. 10 is a flowchart indicating an operation of the apparatus 10 at the time T(i). In the following description, steps S1 and S4 are assumed to be started at the time T(i). However, a starting timing of steps S1 and S4 may be different.

In step S1, the usage amount calculator 13 acquires the usage amount U(T(i)) from a VMM at the time T(i).

In step S2, the usage amount calculator 13 calculates a fixed usage amount fU(i−1) in the time slot Slo_i−1. A method for calculating the fixed usage amount fU(i−1) is as described above. The fixed usage amount fU(i−1) calculated by the usage amount calculator 13 is stored in the usage amount storage 14.

In step S3, the spike detector 15 acquires a fixed usage amount fU(i−2) of the time slot Slo_i−2 and the fixed usage amount fU(i−1) of the time slot Slo_i−1 from the usage amount storage 14, and determines whether a spike has occurred in the time slot Slo_i−1. A method for detecting a spike is as described above. A spike detection result by the spike detector 15 is stored in the spike storage 16.

On the other hand, in step S4, the allocation amount setter 18 sets the allocation amount A(i) to a VMM at the time T(i). The VMM allocates the set allocation amount A(i) to a VM.

In step S5, the allocation amount setter 18 calculates a fixed allocation amount fA(i−1) in the time slot Slo_i−1. A method for calculating the fixed allocation amount fA(i−1) is as described above. The fixed allocation amount fA(i−1) calculated by the allocation amount setter 18 is stored in the usage amount storage 14.

In step S6, the allocation amount calculator 17 acquires the fixed usage amount fU(i+1) of m time slots in the time slot group i+1 from the usage amount storage 14.

In step S7, the allocation amount calculator 17 calculates a temporary allocation amount A(i+1)′ from the fixed usage amount fU(i+1) of the acquired m time slots. A method for calculating the temporary allocation amount A (i+1)′ is as described above.

In step S8, the allocation amount calculator 17 acquires a spike detection result in the time slot group i and the time slot group i+2 from the spike storage 16.

In step S9, the allocation amount calculator 17 calculates the allocation amount A(i+1) based on the temporary allocation amount A(i+1)′ and the acquired spike detection result. A method for calculating the allocation amount A(i+1) is as described above.

Further, after each of the fixed usage amount fU(i−1) and the fixed allocation amount fA(i−1) are calculated in steps S2 and S5, the success rate calculator 19 determines in step S10 whether resource assurance in the time slot Slo_i−1 has succeeded. A method for determining a success or failure of resource assurance is as described above. A determination result is stored in the usage amount storage 14.

After steps S3, S9, and S10, the apparatus 10 waits until the time T(i+1).

FIG. 11 is a table indicating an example of the usage amount storage 14 after the above processing has finished at the time T(3). The fixed usage amount fU(2), the fixed allocation amount fA(2), and a success or failure of resource assurance of the time slot Slo_2 are stored in the usage amount storage 14 by the processing at the time T(3).

As described above, the apparatus 10 according to the embodiment can increase a resource allocation amount to be allocated to time slots before and after the time slot in which a spike has occurred in the past. Therefore, in the case where a time slot in which a spike occurs is shifted back and forth, the apparatus 10 can prevent resource shortage, improve a success rate of resource assurance, and precisely assure a resource.

In addition, an allocation amount of time slots before and after the time slot in which a spike has occurred in the past can be selectively increased, and therefore an increase in the allocation amount can be prevented.

The apparatus 10 according to the embodiment is preferably used for a resource allocation process of a VM which will perform an application having high operating accuracy. A reason thereof will be described below. Examples of an application having high operating accuracy include, but are not limited to, applications for monitoring operation state of a software and operation state of a machine such as an air conditioner. Further, high operating accuracy indicates that operating accuracy is 1 to 1000 milliseconds.

As a conventional method for allocating a resource, a method is proposed in which an average value and a maximum value of a resource usage amount in the past time slot Slo_i are allocated to each time slot Slo_i by dividing a period, in which a resource usage amount is changed, to multiple time slots.

In such a conventional technique, a VM performing an application, of which operating accuracy is approximately several seconds to several minutes, such as a WEB server is assumed as an object of a resource allocation process. Although a response is delayed in the WEB server when a resource is in short, a serious problem does not occur even if the response is delayed for milliseconds.

However, in the above conventional technique, it has been difficult to appropriately allocate a resource to a VM which performs an application having high operating accuracy.

The application having high operating accuracy is likely to cause a spike as illustrated in FIG. 2, and also a time width of a time slot is millisecond order. Therefore, a time slot in which a spike occurs is likely to shift by deviation of a processing timing for several tens microseconds to several milliseconds, which is caused on a general computer and a general-purpose OS. In addition, the application having high operating accuracy uses a large amount of a resource when a spike occurs. However, a small amount of a resource is likely to be used in a normal operation.

In the case where the conventional technique is applied to a VM which performs such an application, an allocation amount depending on a spike usage amount is set to a time slot in which a spike has occurred in the past. However, a small allocation amount depending on a usage amount in a normal operation is set to a time slot other than the above.

Therefore, when the time slot, in which a spike occurs, shifts, a spike occurs in a time slot in which a small allocation amount is set, and a process is delayed since a resource is in short. An application having high operating accuracy might have a significant operational disturbance by a processing delay for several milliseconds.

In the conventional technique, as a method for assuring a resource of an application having high operating accuracy, a method is considered in which an allocation amount is set depending on a spike usage amount. However, a large amount of a resource is allocated in this method even in a normal operation in which a small amount of a resource is used, and a resource is unnecessarily allocated.

On the other hand, in the apparatus 10 according to the embodiment, even in the case where a time slot which has a spike is shifted back and forth, a resource can be precisely assured, and therefore an appropriate allocation amount can be set to a VM which performs an application having high operating accuracy.

FIG. 12 is simulation results of success rates of resource assurance by the apparatus 10 according to the embodiment and the conventional technique. In FIG. 12, a resource is a CPU, and a solid line indicates a success rate by the apparatus 10, and a broken line indicates a success rate by the conventional technique. According to FIG. 12, in the case where operating accuracy is millisecond order, the apparatus 10 indicates a high success rate in comparison with the conventional technique.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A resource allocation apparatus, comprising:
a usage amount calculator configured to calculate a fixed usage amount which is a resource usage amount actually used for each time slot divided as a division of a resource fluctuation period of a virtual machine;
a spike detector configured to detect a spike of the fixed usage amount;
an allocation amount calculator configured to calculate the resource allocation amount to be allocated to the i-th time slot based on the past fixed usage amount in the i-th time slot and a detection result of the past spike in the time slot included in a predetermined range before and after the i-th time slot; and
an allocation amount setter configured to set the allocation amount to a virtual machine monitor which controls the virtual machine.

2. The apparatus according to claim 1, wherein the allocation amount calculator calculates the allocation amount to be allocated to the i-th time slot based on the fixed usage amount in the time slot in which the spike has been detected, in a case where the spike has been detected in the past in the time slot included in a predetermined range before and after the i-th time slot.

3. The apparatus according to claim 1, wherein the fixed usage amount calculator calculates the fixed usage amount based on the usage amount acquired from the virtual machine monitor and an acquisition time of the usage amount.

4. The apparatus according to claim 1, wherein the allocation amount setter calculates a fixed allocation amount which is the allocation amount actually allocated to each of the time slots based on the allocation amount set to the virtual machine monitor and a time when the allocation amount has been set.

5. The apparatus according to claim 1, further comprising a success rate calculator configured to calculate a success rate of assurance of the resource based on the fixed usage amount and the fixed allocation amount for each of the slots.

6. The apparatus according to claim 1, wherein a time width of the time slot is 1 to 10 milliseconds.

7. The apparatus according to claim 1, wherein the resource is any one of a CPU, a memory, a storage, a hard disk, and a network.

8. The apparatus according to claim 1, wherein the time slot included in a predetermined range before and after the i-th time slot is at least either one of (i+1)-th time slot or (i−1)-th time slot.

9. A resource allocation method, comprising:
calculating a fixed usage amount which is a resource usage amount actually used for each time slot of a virtual machine;
detecting a spike of the fixed usage amount;
calculating the resource allocation amount to be allocated to the i-th time slot based on the past fixed usage amount in the i-th time slot and a detection result of the past spike in the time slot included in a predetermined range before and after the i-th time slot; and
setting the allocation amount to a virtual machine monitor which controls the virtual machine.

10. A storage medium storing a program for causing a computer to execute a process, comprising:
calculating a fixed usage amount which is a resource usage amount actually used for each time slot of a virtual machine;
detecting a spike of the fixed usage amount;
calculating the resource allocation amount to be allocated to the i-th time slot based on the past fixed usage amount in the i-th time slot and a detection result of the past spike in the time slot included in a predetermined range before and after the i-th time slot; and
setting the allocation amount to a virtual machine monitor which controls the virtual machine.
